(19) United States
(12) Patent Application Publication
(10) Pub. No.: US 2018/0263038 A1
(43) Pub. Date: Sep. 13, 2018

(54) TRANSMISSION POWER IN ADAPTIVE CCA AND TPC BASED REUSE

(71) Applicant: QUALCOMM Incorporated, San Diego, CA (US)

(72) Inventors: Yan ZHOU, San Diego, CA (US); Gwendolyn Denise BARRIAC, Encinitas, CA (US); George CHERIAN, San Diego, CA (US); Simone MERLIN, San Diego, CA (US); Alfred ASTERJADHI, San Diego, CA (US)

(21) Appl. No.: 15/455,435

(22) Filed: Mar. 10, 2017

(51) Int. Cl. H04W 72/04; H04W 52/34; H04L 1/00

(52) U.S. Cl. CPC H04W 72/0473; H04L 1/0015; H04W 52/346

(57) ABSTRACT

A method, an apparatus, and a computer-readable medium for wireless communication by a wireless device with a first AP are provided. In one aspect, an apparatus is configured to receive a valid Overlapping Basic Service Set (OBSS) PPDU transmission, e.g., transmitted by a second wireless device to a second AP. The apparatus may regard the valid OBSS PPDU as not having been received when a received power of the OBSS PPDU is below an OBSS Packet Detection (PD) level, and determine a transmission power (TXPWR) for a reuse transmission from the wireless device to the first AP based on an OBSS Packet Detection (PD) threshold and based on a TXPWR definition.

### BACKGROUND

### Field

The present disclosure relates generally to communication systems, and more particularly, to transmit power control (TPC) based reuse of resources in wireless communication between a wireless device and an Access Point (AP).

### Background

In many telecommunication systems, communications networks are used to exchange messages among several interacting spatially-separated devices. Networks may be classified according to geographic scope, which could be, for example, a metropolitan area, a local area, or a personal area. Such networks may be designated respectively as a wide area network (WAN), metropolitan area network (MAN), local area network (LAN), wireless local area network (WLAN), or personal area network (PAN). Networks may also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks may be preferred when the network elements are mobile and thus have dynamic connectivity needs, or if the network architecture is formed in an ad hoc, rather than fixed, topology. Wireless networks may employ intangible physical media in an unguided propagation mode using electromagnetic waves in the radio, microwave, infra-red, optical, etc., frequency bands. Wireless networks may facilitate user mobility and rapid field deployment when compared to fixed wired networks.

The ability of a wireless network to handle a number of simultaneous communications is important. Non-interfering communications may be made between a number of wireless devices and access points (APs) through the use of partitions of time, frequency, code, etc. of system resources for different communications. Such partitions may limit the capacity of the wireless network.

### SUMMARY

The systems, methods, computer-readable media, and devices of the disclosure each have several aspects, no single one of which is solely responsible for the invention's desirable attributes. Without limiting the scope of this invention as expressed by the claims, which follow, some features will now be discussed briefly. The following presents a simplified summary of one or more aspects in order to provide a basic understanding of such aspects. The summary is not an extensive overview of all contemplated aspects, and is intended to neither identify key or critical elements of all aspects nor delineate the scope of any or all aspects. The summary's sole purpose is to present some concepts of one or more aspects in a simplified form as a prelude to the more detailed description that is presented later. After considering this discussion, and particularly after reading the section entitled “Detailed Description,” one will understand how the features of this invention may provide advantages for devices in a wireless network.

A transmitter of a Basic Service Set (BSS) may be allowed to transmit radio signals over a shared wireless medium based on a Clear Channel Assessment (CCA). Wireless network capacity may be increased by allowing reuse of transmission resources, e.g., spatial reuse of transmission resources. For example, a wireless device might be able to ignore Overlapping Basic Service Set (OBSS) physical layer convergence protocol (PLCP) data units (PPDUs) that are received when a Received Signal Strength Indication (RSSI) of such PPDUs is at or below an OBSS Packet Detection (PD) level, also referred to herein as an OBSS PD threshold. However, such spatial reuse may lead to interference caused by a wireless device reusing the same resources for communication. The potential interference may be mitigated through the use of transmit power control (TPC) when resources for wireless communication are reused by limiting the transmission power (TXPWR) for a wireless device whose transmission reuses resources of a detected OBSS PPDU in order to reduce the amount of collision with the on-going frame exchange.

A TXPWR limitation may be based on the OBSS PD level used in order to determine whether to reuse the resources and may be further based on a TXPWR definition. The TXPWR definition may be defined or may be dynamically signaled to the wireless device.

In an aspect of the disclosure, a method, a computer-readable medium, and an apparatus are provided for wireless communication by a wireless device with a first AP. The apparatus may be, e.g., a station for wireless communication. The apparatus may receive a valid OBSS PPDU, such as an OBSS frame transmitted by a second wireless device to a second AP. The apparatus may then regard the valid OBSS PPDU as not having been received when a received power of the OBSS PPDU is below an OBSS Packet Detection (PD) level. The apparatus may reuse the OBSS frame for a transmission from the wireless device to the first AP. The apparatus may determine a TXPWR for the reuse transmission from the wireless device to the first AP based on an OBSS PD level and based on a TXPWR definition.

### BRIEF DESCRIPTION OF THE DRAWINGS

FIG. 1 shows an example wireless communication system in which aspects of the present disclosure may be employed.

FIG. 2 illustrates an example of a wireless communication system including OBSS PPDUs from a STA.

FIG. 3 illustrates a graph showing an example relationship between a TXPWR level and an OBSS PD level.

FIG. 4 is a flowchart of an example method of wireless communication.

FIG. 5 shows an example functional block diagram of a wireless device that may perform TPC based reuse within the wireless communication system of FIG. 1.

FIG. 6 is a functional block diagram of an example wireless communication device that performs TPC based reuse.

### DETAILED DESCRIPTION

Various aspects of the novel systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the disclosure. For example, an apparatus may be implemented or a method may be practiced using any number of the aspects set forth herein. In addition, the scope of the invention is intended to cover such an apparatus or method, which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of WLANs. A WLAN may be used to interconnect nearby devices together, employing networking protocols. The various aspects described herein may apply to any communication standard, such as a wireless protocol standard.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Aspects of certain devices implementing the 802.11 protocol may consume less power than devices implementing other wireless protocols, and/or may be used to transmit wireless signals across a relatively long range, for example about one kilometer or longer.

In some implementations, a WLAN may include various devices, which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations, a STA may also be used as an AP.

A STA may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a STA may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not limit the quantity or order of those elements. Rather, such designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, A-A, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. The devices may also be used for surveillance, to enable extended-range Internet connectivity (e.g. for use with hotspots), or to implement machine-to-machine communications.

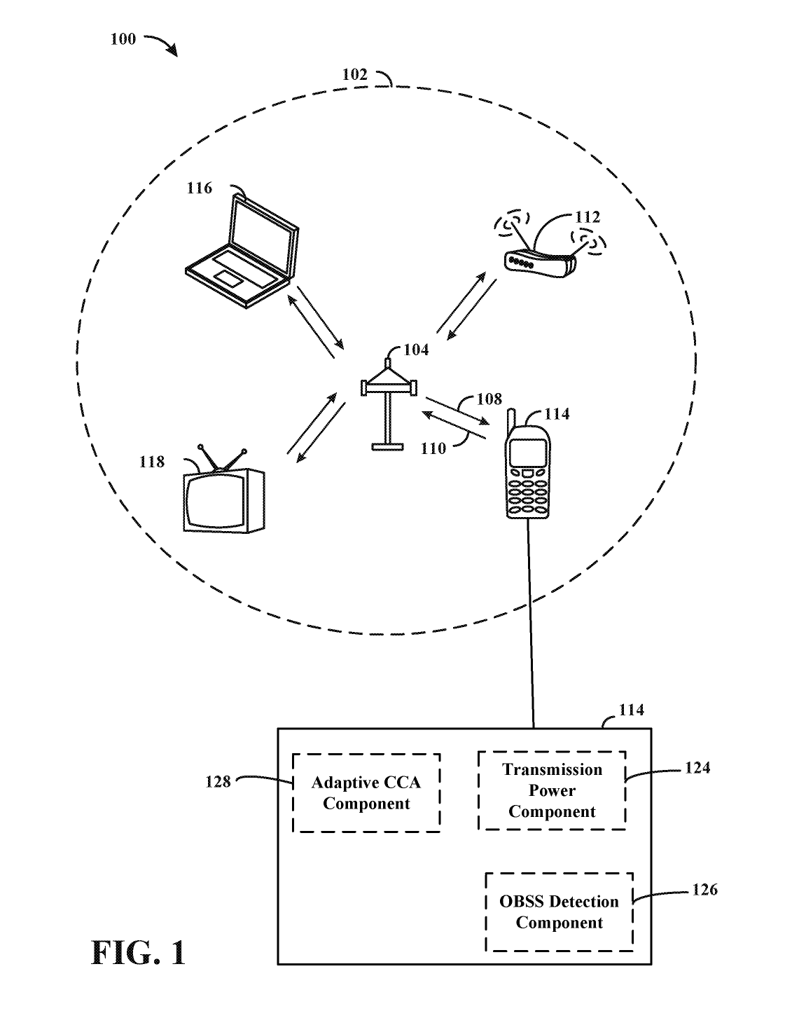

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. In such a case, the wireless communication system 100 may be referred to as an OFDM/OFDMA system. Alternatively, signals may be sent and received between the AP 104 and the STAs in accordance with CDMA techniques. In such a case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or by having a longer ADC backoff period with increased bit widths.

The AP 104 may act as a base station and provide wireless communication coverage in a basic service area (BSA) 102. A BSA (e.g., the BSA 102) may be the coverage area of an AP (e.g., the AP 104). The AP 104 along with the STAs associated with the AP 104 and that use the AP 104 for communication may be referred to as a basic service set (BSS). The wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and information that is specific to a given device.

In some aspects, a STA (e.g., STA 114) may associate with the AP 104 to send communications to and/or to receive communications from the AP 104. In one aspect, information for associating may be included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, either from the beacon or probe response frames, the STA 114 may transmit a reference signal, such as an association probe or request, to the AP 104. In some aspects, the AP 104 may use backhaul services, for example, to communicate with a larger network, such as the Internet or a public switched telephone network (PSTN).

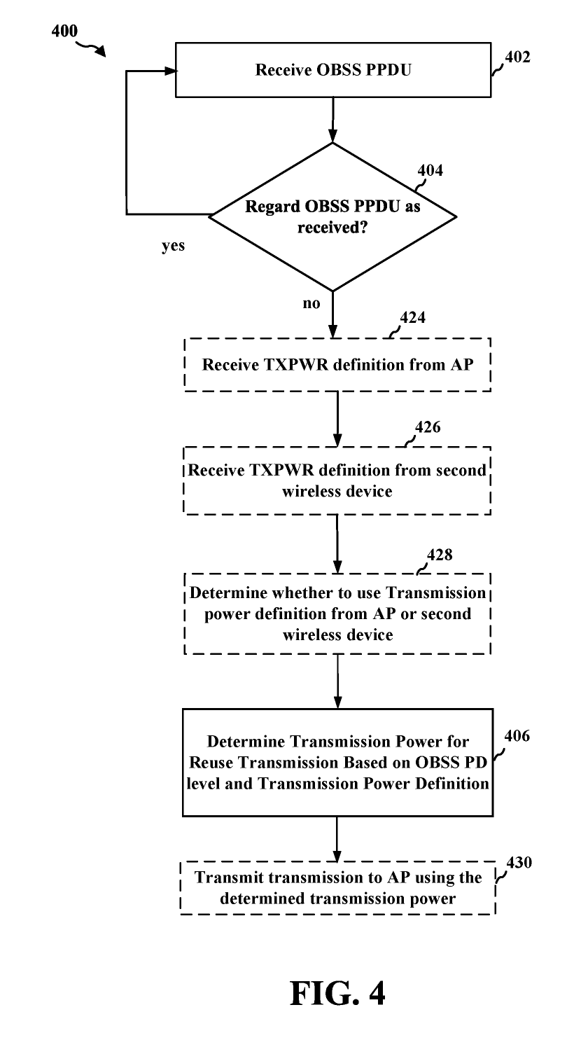

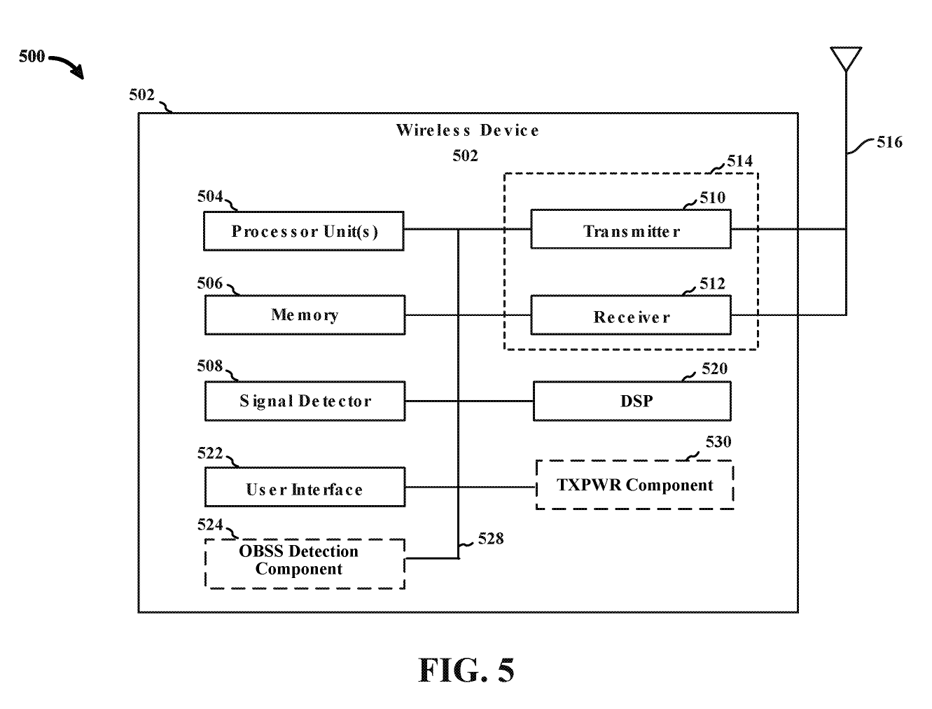

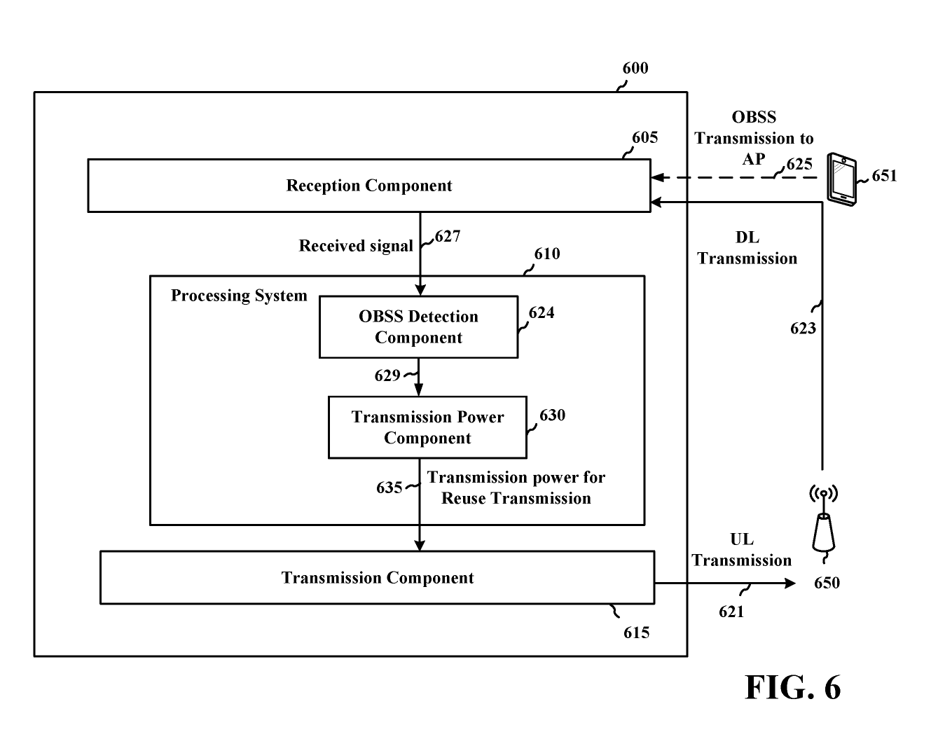

In an aspect, the STA 114 may include one or more components for performing various functions. For example, the STA 114 may include an adaptive CCA component 128 for performing adaptive CCA, and OBSS detection component 126 that detects OBSS PLCP PPDU and determines whether to regard a valid the OBSS PPDU as not having been received. The OBSS detection component 126 may regard the valid OBSS PPDU as not having been received when a received power of the OBSS PPDU is below an OBSS PD level. The STA 114 may also comprise a transmission power component 124 to perform procedures related to determining a transmission power for a transmission from the STA 114 to an AP. The transmission power component 124 may determine the transmission power based on the OBSS PD level and based on a TXPWR definition. The transmission from the STA 114 to the AP may comprise spatial reuse of resources carrying an OBSS transmission from another wireless device. The transmission power component 124 may be configured to perform any of the aspects described in connection with FIG. 4. While transmission power component 124 is illustrated in connection with STA 114, this is merely an example is by way of illustration and not limitation. STA 114 may include other components, e.g., as described in connection with the wireless device 502 of FIG. 5 and the apparatus of FIG. 6. Any of STAs 112, 116, 118 may also comprise a transmission power component 124 and/or a OBSS detection component 126.

A transmitter of a BSS may be allowed to transmit radio signals over a shared wireless medium based on a CCA. A CCA threshold is a receive signal strength level that is used when a device is attempting to transmit on a channel. The device evaluates receive signal strength on the channel before initiating a transmission on the channel. If the receive signal strength on the channel is greater than the CCA threshold (indicating that another device may be transmitting on the channel or energy is otherwise present on the channel at that time), the device refrains from transmitting on the channel. The device may again evaluate receive signal strength on the channel, and when the receive signal strength is less than the CCA threshold, the device can send its transmission on the channel.

A CCA threshold is a power level, e.g., RSSI level, against which a power of detected energy is compared prior to initiating a transmission on a given channel. When the detected energy is less than the CCA threshold, this indicates that there is likely no other activity on the channel and therefore the device can initiate a transmission. Conversely, when the detected energy is greater than the CCA threshold, this indicates that the detected energy is likely associated with another WiFi transmission and the device should therefore temporarily backoff from transmitting for a period of time and make another CCA assessment.

Therefore, when the CCA threshold is higher or lower, this tends to make it easier for the detected energy to be less than the CCA threshold, and thus allow the AP or client to initiate a transmission. A lower CCA threshold requires the receive signal strength on the channel needs to be even lower in order for the device to initiate a transmission, making access to the channel for the device more restrictive. Conversely, when the CCA threshold is higher, the CCA threshold is less likely to be exceeded and therefore the device will have less restrictive access to the channel. Moreover, when the CCA threshold is raised, it may also result in possibly transmitting on the channel in the presence of signals from other devices, and such simultaneous use of the channel (coexistence) impacts the throughput on a wireless link because the interference between the two or more signals on the channel may result in a lower receive signal-to-noise ratio (SNR) and thus more errors and requests for packet retransmissions at the intended receiving device.

In adaptive CCA, a device may adjust or change the CCA threshold that is applied when performing CCA to determine when a channel is clear to transmit.

In an aspect, wireless network capacity may be increased by allowing reuse of transmission resources, e.g., spatial reuse of transmission resources. A device may detect and identify whether a received PPDU is from an inter-BSS or intra-BSS device. The device may determine to perform spatial reuse of transmission resources, e.g., for inter-BSS transmissions. The device may employ an OBSS specific channel access procedure for spatial reuse, e.g., by using an OBSS PD CCA threshold, also referred to herein as an OBSS PD level or OBSS PD threshold. For example, a wireless device might be able to ignore received OBSS PPDUs whose RSSI is at or below an OBSS PD level.

However, such spatial reuse may lead to interference caused by another wireless device reusing the same resources for communication. In an aspect the potential interference may be mitigated through the use of TPC when reusing resources for wireless communication, e.g., the TXPWR for a wireless device whose transmission reuses resources of a detected OBSS PPDU may be limited in order to reduce the amount of collision with the on-going frame exchange. By employing spatial reuse in combination with a corresponding reduction in transmission power increases capacity while mitigating the interference.

The TXPWR limitation may be based on the OBSS PD level used in order to determine whether to reuse the resources. The TXPWR limitation may be further based on a TXPWR definition.

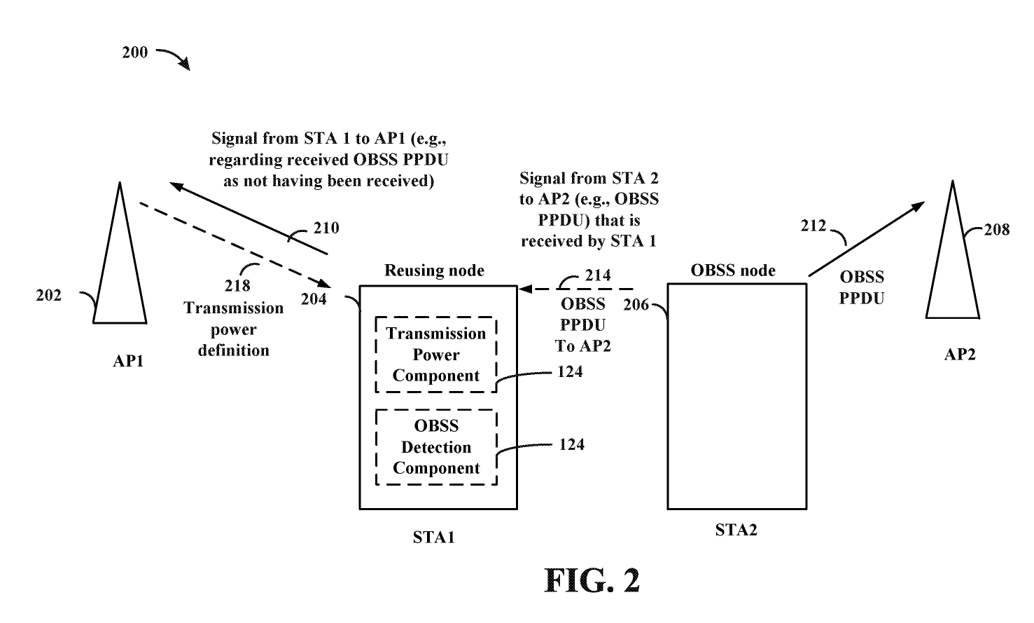

FIG. 2 illustrates an example wireless network 200 having a first AP 202 and first STA 204 transmitting wireless communication 210 to AP 202. Each AP 202, 204 may provide communication coverage for a particular geographic area, which may be called a basic service area (BSA). Overlapping BSSs (OBSS) may occur when the two or more of the BSSs are in close enough proximity to hear each other.

STA1 204 may detect a wireless signal 214 transmitted from STA2 206 to AP2 208. Wireless signal 214 may comprise an OBSS PPDU, for example. Wireless signal 214 may be transmission 212 from STA2 206 to AP2 208. STA1 204 may determine whether to regard the wireless signal 214 as having been received, e.g., STA 204 may regard a valid OBSS PPDU received from STA2 206 as not having been received when a received power of the OBSS PPDU is below an OBSS PD level. In this case, STA1 204 may transmit its own transmission 210 to AP1 202 as though it had not received the wireless signal 214 from STA2 206. The transmission may comprise spatial reuse of resources of wireless signal 214. STA1 204 may first identify whether a received PPDU from STA2 206 is an inter-BSS or an intra-BSS communication. For inter-BSS OBSS PPDUs, STA1 204 may determine whether the detected signal meets an OBSS PD CCA threshold. For example, if the detected wireless signal 214 has a received power below the OBSS PD threshold, STA1 204 may determine to regard the OBSS PPDU, e.g., 214, as not having been received. STA1 204 may compare an RSSI of the detected wireless signal 214 from STA2 206 to the OBSS PD threshold.

If the detected signal is not below the OBSS PD threshold, STA1 204 may regard the OBSS PPDU as having been received and may refrain from reusing the resources of the signal 214. STA1 204 may also employ a TXPWR adjustment when STA1 204 determines to transmit communication 210 to AP1 202 while regarding detected wireless signal 214 as not having been received. The TXPWR value may be based on the OBSS PD threshold employed by STA1 204. For example, a reduction in the TXPWR may be accompanied by an increase in the OBSS PD threshold value.

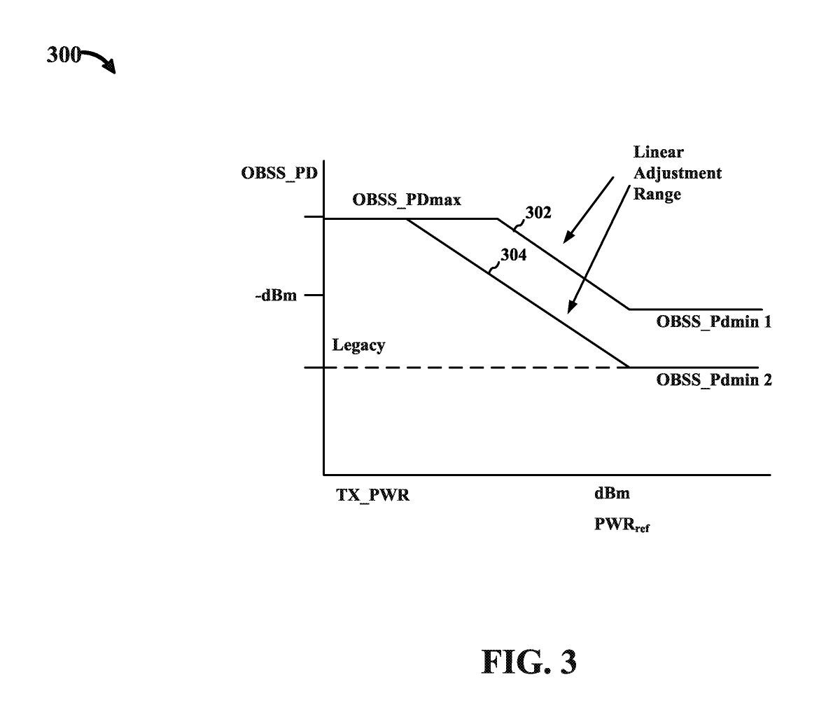

FIG. 3 illustrates a graph showing an example correspondence between a reduction in OBSS PD threshold and an increase in TXPWR. As illustrated in FIG. 3, a linear adjustment range may differ depending on different OBSS PD maximum and OBSS minimum values. FIG. 3 illustrates two example linear adjustment ranges having a same OBSS PB maximum value and different minimum OBSS PD minimum values. In one example, an OBSS PD minimum value may be approximately −74 dBm. In another example, an OBSS PD minimum value may be approximately −82 dBm. An OBSS PD maximum value may be approximately −62 dBm. Other OBSS PD minimum and/or OBSS PD maximum values may also be used to form a linear adjustment range similar to 302, 304 in FIG. 3. The ranges illustrated in FIG. 3 are examples, and a different range may be selected, e.g., when using a different maximum OBSS PD and/or a minimum OBSS PD. However, FIG. 3 illustrates that a reduction in OBSS PD threshold may correspond to an increase in TXPWR for the transmission from STA1 204 to AP1 202 when reusing resources of a detected OBSS within wireless signal 214 from STA2 206.

For example, STA1 204 may regard a valid, received OBSS PPDU from STA2 as not having been received at all (e.g., not updating its NAV), if the received power (RXPWR) of the received PPDU 214 is below the OBSS PD threshold, e.g., using OBSS detection component 126. Thus, STA1 204 may ignore the OBSS PPDU 214 from STA2 206 and transmit on top of, e.g., reuse, the OBSS resources of the detected wireless signal, e.g., OBSS PPDU 214. In an aspect, additional conditions may be considered in the determination of whether to regard the valid OBSS PPDU as not having been received. STA1 204 may indicate the medium condition as BUSY during the period of time that is taken by STA1 204 to validate that the PPDU 214 from STA2 206 is from an Inter-BSS, but not longer than the time indicated as the length of the PPDU payload. The OBSS PD threshold may have a corresponding TXPWR value and a reduction in the TXPWR may be accompanied by an increase in the OBSS PD threshold value, e.g., similar to the relationship illustrated in FIG. 3. Thus, the OBSS PD threshold used by STA1 in determining whether to regard the valid OBSS PPDU wireless signal 214 as having not been received may increase, with a corresponding reduction in STA1's TXPWR.

Thus, in determining whether the RXPWR of wireless signal 214 is below the OBSS PD threshold, STA1 204 may compare the RXPWR to a point along a corresponding linear adjustment range 302 or 304. The selection of this point enables STA1 to identify an OBSS PD threshold and to determine a corresponding TXPWR, e.g., using transmission power component 124, based on the OBSS PD threshold that STA1 should use when it determines that the RSSI of OBSS PPDU signal 214 from AP2 206 is below the identified OBSS PD threshold.

If STA1 204 determines that the RSSI of OBSS PPDU signal 214 from STA2 is below the identified OBSS PD threshold, STA1 may regard the valid OBSS PPDU 214 as not having been received and may transmit a transmission to AP1 202 using the determined TXPWR corresponding to the identified OBSS PD threshold.

The TXPWR used by STA1 204 may also take into consideration other factors such as, TXPWR definitions. Example TXPWR definitions may be based on antenna number, defining a TXPWR value or a TXPWR limit, or defining a correspondence between the TXPWR and an MCS, and/or restricting TXPWR based on certain conditions of the reusing OBSS frames and/or of the detected OBSS frames.

The TXPWR definition(s) may be defined or may be dynamically signaled to the wireless device.

{{Transmission Power Dependence on TX Antenna Number}}

For example, STA1 204 may include multiple transmission antennas. Therefore, the TXPWR used by STA1 may be based on a limitation that STA1 204 uses per transmission antenna. In this example, the same limit may be applied to each transmit antenna individually. When STA1 204 regards an OBSS PPDU as not having been received and transmits communication to AP1 202 with multiple antennas using the TXPWR, more interference may be generated. Therefore, in another aspect, STA1 204 may limit a combined power from all of its transmission antennas to TXPWR. This combined power limitation may enable the interference generated by STA1 204 to be better controlled. This combined power limitation also allows STA1 to use all transmit antennas or any selected subset of transmission antennas, as long as the combined transmission power is at or below TXPWR.

{{Limitation/Actual Value}}

The TXPWR determined based on the OBSS PD threshold may indicate the actual transmission power that STA1 may use when regarding OBSS PPDU 214 as not having been received and transmitted to AP1 202. Thus, STA1 204 may transmit to AP1 204 using TXPWR, e.g., based on the OBSS PD threshold used to determine whether to regard OBSS PPDU 214 as having been received.

Alternately, the determined TXPWR may indicate a maximum power that STA1 may use to transmit to AP1 202. This allows STA1 204 to select any transmission power up to the determined TXPWR for transmitting to AP1 202.

{{Dependence of Transmission Power on MCS}}

In one aspect, the TXPWR for transmitting to AP1 202 when regarding OBSS PPDU 214 as not having been received may be determined based on OBSS PD threshold and may be independent of a modulation coding scheme (MCS). Thus, the TXPWR limitation determined based on the OBSS PD threshold may be used by STA1 for all MCSs.

In a second aspect, the TXPWR limitation may only apply to a reference MCS.

A reference MCS may be fixed, e.g., by a standard. For example, MCS 0 might be defined as the reference MCS. Alternately, a reference MCS may be dynamically determined by the associated AP, e.g., AP1 202, or reusing STA, e.g., STA1 204. If the reference MCS is determined by AP1 202, AP1 202 would signal the reference MCS to STA1 204.

When a TXPWR for reference MCS is specified, the TXPWR for the other MCSs may be a function of the TXPWR for the reference MCS. For example, the TXPWR for MCS 9 may correspond to the TXPWR for the reference MCS along with an offset. The correspondence between the TXPWR of the reference MCS and the TXPWR for different MCSs may be the same. In another example, the correspondence between the TXPWR of the reference MCS and the TXPWR for different MCSs may be different. The correspondence between MCSs and the reference MCS may be defined, e.g., in a standard, or may be signaled, e.g., at 214, to STA1 204 by an associated AP.

{{Restrictions on Transmission Power}}

STA1 204 may determine a TXPWR according to additional factors beyond the OBSS PD threshold, for example, conditions regarding the frame for the transmission 210 and/or the detected OBSS frame for the OBSS signal 214.

In one example, STA1 204 may use a different TXPWR for transmitting different frames of different data traffic types and/or may use a different TXPWR based on the data traffic type of the OBSS frame 214. Thus, the TXPWR determined by STA1 for transmission 210 may be different for different categories of data transmissions. The UE may determine a TXPWR based on any of a traffic identifier, an access category, a traffic class, etc. of the transmission that the UE will transmit reusing the resources of the detected OBSS transmission. Thus, the TXPWR for a reuse transmission may be different for voice, video, or background traffic transmissions from STA1 204. Likewise, the TXPWR may be different for different types of the detected OBSS frame 214.

In a second example, STA1 204 may use a different TXPWR for transmitting frames of different types or subtypes and/or may use a different TXPWR based on the type or subtype of the OBSS frame 214. For example, STA1 204 may determine a different TXPWR when transmitting control frames than the TXPWR used for transmitting data frames when a transmission reuses resources of the detected OBSS transmission. Similarly, STA1 204 may use a different TXPWR based on the type of the detected OBSS frame 214.

In a third example, STA1 204 may use a different TXPWR for transmissions 210 based on the STA or STA type of the frame of transmission 210 and/or the OBSS frame of transmission 214. Thus, a first TXPWR may be used by STA1 for transmitting to AP1 202 when regarding OBSS frames from a first group of STAs/nodes as not having been received. A second TXPWR may be used by STA1 for transmitting to AP1 202 when regarding OBSS frames from a second group of STAs/nodes as not having been received. A group classification of STAs/nodes may be determined, e.g., by AP1 202 and communicated to STA1 by AP1. In an example, the group classification may be based on associated/non-associated STAs. Thus, STA1 may determine a first TXPWR for OBSS frames 214 from associated STAs/nodes and a second TXPWR for OBSS frames 214 from non-associated STAs/nodes. The group classification may also be determined based on other criteria. For example, STAs may be classified as an edge STA or an inner STA relative to an associated AP. The classification may be based on, e.g., a path loss to the associated AP. A higher TXPWR may be used when OBSS frames 214 from inner STAs than for reusing OBSS frames of an edge STA. For example, if STA2 were an inner STA, STA1 may use a higher TXPWR than STA1 would use if STA2 were an edge STA. Inner STAs will typically experience fewer contenders and therefore are likely to have more air time.

In a fourth example, STA1 204 may use a different TXPWR based on an information type of the transmission to AP1 202 and/or the detected OBSS frame 214. Such information types for may include, among others, feedback of sounding, buffer status, CQI, and data. For example, STA1 may determine a first TXPWR for reusing OBSS frames for transmitting CQI and a second TXPWR for reusing OBSS frames for transmitting data. In another example, STA1 may determine to use a first TXPWR for transmitting a buffer status and a second TXPWR for transmitting feedback of sounding. In yet another example, STA1 may determine to use a first TXPWR for transmitting a buffer status and a second TXPWR for transmitting data. In yet another example, STA1 may determine a first TXPWR for reusing OBSS frames for transmitting voice traffic and a second TXPWR for reusing OBSS frames for transmitting file-uploading traffic.

In a fifth example, STA1 204 may use a different TXPWR for different link types for the transmission 210 to AP1 202 and/or the OBSS frame 214. For example, STA1 204 may use a different TXPWR depending on whether the transmission will be DL, UL, or P2P. Likewise, STA1 204 may use a different TXPWR depending on whether the detected OBSS frame was DL, UL, both, or P2P.

In a sixth example, STA1 204 may use a different TXPWR for transmitting to AP1 when regarding OBSS frames 214 on certain resources as not having been received. For example, a TXPWR limitation might apply to frames in a certain time window and/or in a particular bandwidth. Other times/bandwidths may not have a TXPWR limitation or may have a different TXPWR limitation.

In a seventh example, STA1 204 may use a different TXPWR for transmitting to AP1 202 when regarding OBSS frames 214 from certain OBSSs as not having been received. This would provide for a different level of protection to different OBSSs. For example, TXPWR can be lower for OBSSs operated by the same operator or with the same SSID.

The TXPWR and correspondence of TXPWR to an OBSS PD threshold may be defined in a standard. The additional TXPWR definitions and/or restrictions may similarly be defined in a standard. Therefore, STA1 204 may determine TXPWR for reuse based on the OBSS PD as defined in a standard. For example, the TXPWR's dependence on the number of transmission antennas, may be defined in a standard. Similarly, whether the TXPWR corresponding to the OBSS PD threshold is an actual transmission power that should be used by the STA1 or whether it is an upper limit on a transmission power by the STA1 may be defined in a specification. For example, the TXPWR is an upper limit, the STA1 may select a transmission power below the TXPWR. TXPWR's relation to MCS may also be defined. TXPWR restrictions, e.g., based on data traffic type, frame type/subtype, STA type, information type, DL, UL, P2P link, certain resources, and certain OBSSs may also be defined.

In an aspect, any of the TXPWR and the TXPWR's correspondence to an OBSS PD threshold, the TXPWR definitions may be dynamically signaled to STA1 204.

In one example, STA1 204 may receive dynamic signaling 218 of TXPWR definitions in the OBSS frame from STA2 206. In an example, the signaling may indicate whether TXPWR is for per-antenna or across all used antenna and/or whether there are restrictions on TXPWR for certain frames. STA 1 204 may use the signaled definition and/or restriction in determining the TXPWR based on the OBSS PD threshold. STA1 204 may use the signaled definition/restriction when regarding a particular OBSS frame or for all OBSS frames from the same sender/BSS as not having been received.

In another aspect, AP1 202 may dynamically signal definitions for TXPWR to STA1 204. Then, STA1 204 may use the use the signaled definition when regarding OBSS frames meeting conditions of the definition as not having been received from AP1 202.

In a third aspect, STA1 204 may receive dynamic signaling from both STA2 206 and AP1 202. STA1 204 may use a priority rule in order to determine whether to apply the definition received from STA2 206 or AP1 202. In an example priority rule, dynamic signaling in an OBSS frame 214 from STA2 206 may override signaling from associated AP1 202. In another example priority rule dynamic signaling from associated AP1 202 may override signaling in the detected OBSS frame 214.

FIG. 4 is a flowchart of an example method 400 of wireless communication by a wireless device with a first access point (AP). The method 400 may be performed using an apparatus (e.g., STA 112, 114, 116, 118, STA1 204 the wireless device 500, or wireless communication device 600, for example). Although the method 400 is described below with respect to the elements of wireless device 500 of FIG. 5, other devices and other components may be used to implement one or more of the blocks described herein. Certain blocks illustrate optional aspects and are depicted with a dashed box.

At 402, the wireless device 500 may receive a valid OBSS PPDU, e.g., a valid OBSS PPDU from a second wireless device to a second AP. As described in connection with FIG. 2, STA1 204 may detect a wireless signal 214 including an OBSS frame transmitted by STA2 206 to AP2 208.

At 404, the wireless device 500 may determine whether to regard the valid OBSS PPDU as having been received. For example, the wireless device may regard the valid OBSS PPDU as not having been received when a received power of the OBSS PPDU is below an OBSS PD level. For example, in FIG. 2, STA1 204 may determine whether to ignore an OBSS PPDU, e.g., and to transmit on top of, resources used in the detected OBSS PPDU 214 from STA 2 206 to AP2 208 in order to transmit communication 210 to AP1 202. The wireless device may make a determination, e.g., in connection with 404, regarding whether to reuse resources for a transmission to AP1 202 based on whether an RSSI of the detected OBSS PPDU transmitted by the second wireless device, e.g. STA2 206 is less than an OBSS PD threshold. In one example, a required TXPWR may be determined for a transmission from STA1 reusing the resources of the OBSS transmission from STA2. Then, based on the required TXPWR, STA1 may determine a corresponding OBSS PD threshold using a TXPWR-OBSS_PD mapping curve, such as illustrated in FIG. 3. In a second example, an AP may set an OBSS PD threshold at each STA. Therefore, STA1 may receive an OBSS PD threshold from AP1. If the RSSI of the detected OBSS frame from STA 2 is less than the OBSS PD threshold, the wireless device, e.g., STA1, may continue to 406. If the RSSI of the detected OBSS frame from STA1 is more than the OBSS PD threshold, the wireless device may refrain from reusing the OBSS frame and may later perform another CCA.

At 406, once the wireless device regards the OBSS PPDU as not having been received, the wireless device 500 determines a TXPWR for a reuse transmission from the wireless device to the first AP. The determination of the TXPWR for the reuse transmission may be based on an OBSS PD level applied in the determination at 404 and may be further based on a TXPWR definition. The valid OBSS PPDU may be received, e.g., when the wireless device performs a clear channel assessment (CCA), such as adaptive CCA, and the TXPWR may be determined according to transmit power control based reuse. Thus, the method illustrated in FIG. 4 may involve adaptive CCA and TPC based reuse. A TXPWR level may be associated with the OBSS PD threshold used to determine whether to regard the valid OBSS PPDU as having been received, e.g., the OBSS PD threshold used to determine whether to reuse the OBSS frame. For example, a relation, such as one of the example relationships illustrated in FIG. 3 may be used to select a TXPWR based on the OBSS PD threshold used by the wireless device 500.

The TXPWR may further be based on a TXPWR definition in addition to the OBSS PD threshold. In one example, the TXPWR definition may place a restriction on the TXPWR to be used when a wireless device regards a valid OBSS PPDU as not having been received and reuses resources of the OBSS PPDU for a transmission.

A TXPWR definition may relate to a number of transmit antennas used by the wireless device 500 for the reuse transmission. The TXPWR based on the OBSS PD may be a limitation that the wireless device uses per transmission antenna, even if the wireless device transmits using multiple transmit antennas. Thus, the TXPWR definition may define the TXPWR for the reuse transmission per transmission antenna at the wireless device. Alternately, TXPWR based on the OBSS PD may be a combined limitation for multiple transmit antennas used by the wireless device, e.g., all transmit antennas used by wireless device 500 as a part of determining the TXPWR for the reuse transmission. Thus, the TXPWR definition may define the TXPWR as a combined TXPWR for multiple transmission antennas at the wireless device.

A TXPWR definition may relate to whether the TXPWR based on the OBSS PD is an actual value to be used by the wireless device or whether it is an upper limit on transmission power to be used by the wireless device. Thus, the wireless device may transmit the reuse transmission to the first AP, e.g., at 430, using the determined TXPWR based on the OBSS PD, e.g., when the TXPWR definition indicates that the TXPWR is the actual power to be used by the wireless device. Alternately, the wireless device may transmit the reuse transmission to the first AP, e.g., at 430, using a TXPWR below the determined TXPWR, e.g., when the TXPWR definition indicates that the TXPWR is merely an upper limit on the power to be used by the wireless device.

The TXPWR definition may relate to the MCS of the reuse transmission. The TXPWR definition may define the TXPWR independent of the MCS. Certain TXPWR limitations may only apply to certain MCSs, e.g., such as a reference MCS. Additionally, the TXPWR for a particular MCS may be determined as a function of the TXPWR for a reference MCS. The TXPWR definition may define a TXPWR for a second MCS as a function of the TXPWR of a reference MCS. The functions used to determine the TXPWR for different MCSs may be the same or may be different. The function between MCSs and the reference MCS may be defined, e.g., in a standard e.g., as at 426, or may be signaled to the wireless device at 424 by an associated AP, e.g., the first AP.

The TXPWR restriction may restrict the TXPWR based on any of a number of parameters. In one example, the TXPWR definition may define the TXPWR for the reuse transmission based on a first data traffic type of the reuse transmission from the wireless device to the first AP or a second data traffic type of the detected OBSS frame. Thus, the TXPWR for the reuse transmission may be different for different categories of data transmissions by the wireless device. The wireless device may determine a TXPWR based on any of a traffic identifier, an access category, a traffic class, etc. for the transmission Thus, the TXPWR may be different for voice, video, and background traffic transmissions.

In a second example, the TXPWR definition may define the TXPWR for the reuse transmission based on a first frame type or frame subtype of the reuse transmission from the wireless device to the first AP or a second frame type or frame subtype of the detected OBSS PPDU. For example, the wireless device may determine a different TXPWR for control frames than for data frames.

In a third example, the TXPWR definition may define the TXPWR for the reuse transmission based on the identity of the second wireless device or an identify of a second wireless device that transmits the valid OBSS PPDU received by the wireless device. For example, the wireless device may determine a different TXPWR for different groups or classes of STAs/nodes. A group classification of STAs/nodes may be determined, e.g., by the first AP and communicated to wireless device. In one example, the group classification may be based on associated/non-associated wireless devices. The group classification may also be determined based on other criteria.

In a fourth example, the TXPWR definition defines the TXPWR for the reuse transmission based on a first type of information comprised in the transmission from the wireless device to the first AP or a second type of information included in the detected OBSS PPDU. Such information types for determining TXPWR may include, among others, feedback of sounding, buffer status, CQI, and data. For example, the TXPWR definition may define a first TXPWR for transmitting a buffer status and a second TXPWR for transmitting a different type of information.

In a fifth example, the TXPWR definition may define the TXPWR for the reuse transmission based on a first link type of the transmission from the wireless device to the first AP or a second link type of the detected OBSS frame. For example, the wireless device may use a different TXPWR for frames in DL, UL, both, or P2P links.

In a sixth example, the TXPWR definition may define the TXPWR for the reuse transmission based on a resource of the transmission from the wireless device to the first AP. For example, the wireless device may apply a TXPWR limitation to frames within a certain time window and/or within a particular bandwidth.

In a seventh example, the TXPWR definition may define the TXPWR for the reuse transmission based on an OBSS source of the received OBSS PPDU. For example, the wireless device may use a different TXPWR for OBSS PPDUs received from certain OBSSs, thereby providing a different level of protection to different OBSSs.

The TXPWR definition may be defined, e.g., in a standard. Thus, the wireless device may use a defined TXPWR definition to determine the TXPWR for the reuse transmission at 422. In another example, the TXPWR definition/restriction may be dynamically signaled to the wireless device. Thus, at 424, the wireless device 500 may receive the TXPWR definition from the first AP. The wireless device may then use the TXPWR definition received from the first AP to determine the TXPWR for the reuse transmission. Similarly, at 426, the wireless device may receive the TXPWR definition from the second wireless device, e.g., the second wireless device that transmits the received OBSS PPDU. The wireless device may then use the TXPWR definition received from the second wireless device to determine the TXPWR for the reuse transmission.

The wireless device may receive a first TXPWR definition from the AP at 424 and may also a second TXPWR definition from the second wireless device at 426. Determining the TXPWR for the reuse transmission may then include using a priority rule to determine whether to use the first TXPWR definition or restriction or the second TXPWR definition for the reuse transmission at 428.

Once the wireless device determines the TXPWR based on the OBSS PD threshold used by the wireless device and further based on a TXPWR definition at 406, the wireless device may transmit the reuse transmission to the first AP at 430 using the determined TXPWR. In another example, the wireless device may transmit the reuse transmission to the first AP using a TXPWR below the determined TXPWR. Thus, the determined TXPWR may provide an upper limit for the TXPWR.

FIG. 5 shows an example functional block diagram of a wireless device 500 that may perform wireless communication a first AP including determining a transmission power when regarding a valid OBSS PPDU from a second wireless device as having not been received, e.g., within the wireless communication system 100 of FIG. 1 or 200 of FIG. 2. The wireless device 500 is an example of a device that may be configured to implement the various methods described herein. For example, the wireless device 500 may comprise one of the STAs 112, 114, 116, 118.

The wireless device 500 may include at least one processor 504, which controls operation of the wireless device 500. The processor 504 may also be referred to as a central processing unit (CPU). Memory 506, which may include both read-only memory (ROM) and random access memory (RAM), may provide instructions and data to the processor 504. A portion of the memory 506 may also include non-volatile random access memory (NVRAM). The processor 504 may perform logical and arithmetic operations based on program instructions stored within the memory 506. The instructions in the memory 506 may be executable (by the processor 504, for example) to implement the methods described herein.

The processor 504 may comprise or be a component of a processing system implemented with one or more processors. The one or more processors may be implemented with any combination of general-purpose microprocessors, microcontrollers, DSPs, FPGAs, PLDs, controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 500 may also include a housing 502, and the wireless device 500 may include a transmitter 510 and/or a receiver 512 to allow transmission and reception of data between the wireless device 500 and a remote device. The transmitter 510 and the receiver 512 may be combined into a transceiver 514. An antenna 516 may be attached to the housing 502 and electrically coupled to the transceiver 514. The wireless device 500 may also include multiple transmitters, multiple receivers, multiple transceivers, and/or multiple antennas.

The wireless device 500 may also include a signal detector 508 that may be used to detect and quantify the level of signals received by the transceiver 514 or the receiver 512. The signal detector 508 may detect such signals as total energy, energy per subcarrier per symbol, power spectral density, and other signals. The wireless device 500 may also include a DSP 520 for use in processing signals. The DSP 520 may be configured to generate a packet for transmission. In some aspects, the packet may comprise a physical layer convergence protocol (PLCP) data unit (PPDU).

The wireless device 500 may further comprise a user interface 522 in some aspects. The user interface 522 may comprise a keypad, a microphone, a speaker, and/or a display. The user interface 522 may include any element or component that conveys information to a user of the wireless device 500 and/or receives input from the user.

For example, receiver 512 may receive a valid OBSS PPDU, e.g., from a second STA, which may be detected by signal detector 508. For example, receiver 512 may receive OBSS PPDU 214, e.g., transmitted from STA2 to AP2 in FIG. 2

When the wireless device 500 is implemented as a STA (e.g., the STA 114), the wireless device 500 may also comprise an OBSS detection component 524 that determines whether to regard the valid OBSS PPDU as having been received based on an OBSS PD level. For example, the OBSS detection component 524 may regard the valid OBSS PPDU as not having been received when a received power of the OBSS PPDU is below an OBSS PD level. The wireless device 500 may comprise a transmission power component 530 that determines a TXPWR for a reuse transmission from the wireless device to a first AP, e.g., AP1 in FIG. 2, based on the OBSS PD level and based on a TXPWR definition. The transmission may involve spatial reuse, for example. The transmission power component 530 may perform, e.g., any of the aspects described in connection with 406 in FIG. 4. Components 524, 530 may be configured to perform each of the functions and/or steps recited in disclosure with respect to FIGS. 2-4. The various components of the wireless device 500 may be coupled together by a bus system 526. The bus system 526 may include a data bus, for example, as well as a power bus, a control signal bus, and a status signal bus in addition to the data bus. Components of the wireless device 500 may be coupled together or accept or provide inputs to each other using some other mechanism.

Although a number of separate components are illustrated in FIG. 5, one or more of the components may be combined or commonly implemented. For example, the processor 504 may be used to implement not only the functionality described above with respect to the processor 504, but also to implement the functionality described above with respect to the signal detector 508, the DSP 520, the user interface 522, OBSS detection component 524, and/or the transmission power component 530. Further, each of the components illustrated in FIG. 5 may be implemented using a plurality of separate elements.

FIG. 6 is a functional block diagram of an example wireless communication device 600 that performs wireless communication with an access point 650, including determining a transmission power when regarding a valid OBSS PPDU from a second wireless device 651 as having not been received. The wireless device 600 may be a STA, e.g., such as STA 112, 114, 116, 118, 204, or 502. The wireless communication device 600 may include a reception component 605 that receives DL communication 623 from AP 650 and that receives an OBSS PPDU transmission 625 that the second wireless device 651 transmits an UL transmission 621, e.g., to a different AP. The wireless communication device 600 includes a transmission component 615 that transmits UL communication 621 to AP 650 and a processing system 610 that processes signals 623, 625 received at reception component 605 and communication to be transmitted by transmission component 615.

The processing system 610 may comprise an OBSS detection component 624 that regards the valid OBSS PPDU 625 from wireless device 651 as not having been received when a received power of the OBSS PPDU is below an OBSS Packet Detection (PD) level. For example, the reception component 605 may provide the received OBSS PPDU in 627 to the OBSS Detection Component 614, which determines whether to regard the OBSS PPDU as having been received. When the OBSS detection component 624 determines to regard the OBSS PPDU 635 as not having been received, it may provide an indication 631 to transmission power component 630, which determines a TXPWR for the transmission reusing the OBSS resources. transmission power component 630 may determine the TXPWR for the transmission based on the OBSS PD threshold used to determine whether to reuse the OBSS resources and further based on a TXPWR definition, e.g., as described in connection with 406 in FIG. 4. The transmission power component 630 may provide the determined TXPWR 635 to the transmission component 615. The transmission component may then use the determined TXPWR to transmit the transmission reusing the detected OBSS resources.

The reception component 605, the processing system 610, the OBSS detection component 624, the transmission power component 630, and/or the transmission component 615 may be configured to perform one or more functions discussed above with respect to FIGS. 2-4. As such, each block in the aforementioned flowcharts of FIG. 4 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The reception component 605 may correspond to the receiver 512. The processing system 610 may correspond to the processor 504. The transmission component 615 may correspond to the transmitter 510. The OBSS detection component 624 may correspond to the OBSS detection component 524. The transmission power component 630 may correspond to the transmission power component 124 and/or transmission power component 530.

Moreover, means for performing the various described function is described herein. In one configuration, the apparatus 500/600 for wireless communication includes means for receiving a valid OBSS PPDU transmitted by a second wireless device, means for regarding the valid OBSS PPDU as not having been received when a received power of the OBSS PPDU is below an OBSS Packet Detection (PD) level, means for receiving the TXPWR definition, means for determining a TXPWR for a reuse transmission from the wireless device to the first AP based on the OBSS PD level and based on a TXPWR definition, and means for transmitting to the first AP. The aforementioned means may be one or more of the aforementioned components of the apparatus 500 and/or the processor unit(s) 504/processing system 610 configured to perform the functions recited by the aforementioned means.

The various operations of methods described above may be performed by any suitable means capable of performing the operations, such as various hardware and/or software component(s), circuits, and/or component(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an ASIC, a FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium storing computer executable code. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A method of wireless communication by a wireless device with a first access point, comprising:
receiving an Overlapping Basic Service Set (OBSS) physical layer convergence protocol (PLCP) data unit (PPDU);
regarding the OBSS PPDU as not having been received when a received power of the OBSS PPDU is below an OBSS Packet Detection (PD) level; and
determining a transmission power (TXPWR) for a reuse transmission from the wireless device to the first access point based on the OBSS Packet Detection (PD) level and based on a TXPWR definition.

2. The method of claim 1, wherein the TXPWR definition defines the TXPWR for the reuse transmission per transmission antenna at the wireless device.

3. The method of claim 1, wherein the TXPWR definition defines the TXPWR as a combined TXPWR for multiple transmission antennas at the wireless device.

4. The method of claim 1, wherein the wireless device transmits the reuse transmission to the first access point using the determined TXPWR.

5. The method of claim 1, wherein the wireless device transmits the reuse transmission to the first access point using a TXPWR below the determined TXPWR.

6. The method of claim 1, wherein the TXPWR definition defines the TXPWR independent of modulation coding scheme (MCS).

7. The method of claim 1, wherein the TXPWR definition defines the TXPWR for a second MCS as a function of the TXPWR of a reference MCS.

8. The method of claim 1, wherein the TXPWR definition defines the TXPWR based on a first data traffic type of the reuse transmission from the wireless device to the first access point or a second data traffic type of the received OBSS PPDU.

9. The method of claim 1, wherein the TXPWR definition defines the TXPWR for the reuse transmission based on a first frame type or subtype of the reuse transmission from the wireless device to the first access point or a second frame type or subtype of the received OBSS PPDU.

10. The method of claim 1, wherein the TXPWR definition defines the TXPWR for the reuse transmission based on an identity of the wireless device or of a second wireless device that transmits the OBSS PPDU received by the wireless device.

11. The method of claim 1, wherein the TXPWR definition defines the TXPWR for the reuse transmission based on a first type of information comprised in the reuse transmission from the wireless device to the first access point or a second type of information comprised in the received OBSS PPDU.

12. The method of claim 1, wherein the TXPWR definition defines the TXPWR for the reuse transmission based on a first link type of the reuse transmission from the wireless device to the first access point or a second link type of the received OBSS PPDU.

13. The method of claim 1, wherein the TXPWR definition defines the TXPWR for the reuse transmission based on a resource of the reuse transmission from the wireless device to the first access point.

14. The method of claim 1, wherein the TXPWR definition defines the TXPWR for the reuse transmission based on an OBSS source of the received OBSS PPDU.

15. The method of claim 1, wherein the wireless device uses a defined TXPWR definition to determine the TXPWR for the reuse transmission.

16. The method of claim 1, further comprising:
receiving the TXPWR definition from at least one of the first access point and a second wireless device.

17. The method of claim 16, wherein the wireless device receives a first TXPWR definition from the first access point and a second TXPWR definition from the second wireless device, the method further comprising:
using a priority rule to determine whether to use the first TXPWR definition or the second TXPWR definition to determine the TXPWR for the reuse transmission.

18. The method of claim 1, wherein the OBSS PPDU is received when the wireless device performs a clear channel assessment, and wherein the TXPWR is determined according to transmit power control based reuse.

19. An apparatus for wireless communication by a wireless device with a first access point, comprising:
a memory; and
at least one processor coupled to the memory and configured to:
receive an Overlapping Basic Service Set (OBSS) physical layer convergence protocol (PLCP) data unit (PPDU);
regard the OBSS PPDU as not having been received when a received power of the OBSS PPDU is below an OBSS Packet Detection (PD) level; and
determine a transmission power (TXPWR) for a reuse transmission from the wireless device to the first access point based on the OBSS Packet Detection (PD) level and based on a TXPWR definition.

20. A computer-readable medium storing computer executable code for wireless communication by a wireless device with a first access point, comprising code to:
receive an Overlapping Basic Service Set (OBSS) physical layer convergence protocol (PLCP) data unit (PPDU);
regard the OBSS PPDU as not having been received when a received power of the OBSS PPDU is below an OBSS Packet Detection (PD) level; and
determine a transmission power (TXPWR) for a reuse transmission from the wireless device to the first access point based on the OBSS Packet Detection (PD) level and based on a TXPWR definition.
